(19) United States
(12) Patent Application Publication
(10) Pub. No.: US 2010/0088671 A1
(43) Pub. Date: Apr. 8, 2010

(54) PROJECT SCOPES FOR CONFIGURATION BASED COMPUTER APPLICATION PROJECTS

(76) Inventors: Heiko Rentsch, Dresden (DE); Christian Gunsel, Dresden (DE)

Correspondence Address: SEED INTELLECTUAL PROPERTY LAW GROUP PLLC, 701 FIFTH AVE, SUITE 5400, SEATTLE, WA, 98104, US

(21) Appl. No.: 12/247,189

(22) Filed: Oct. 7, 2008

(51) Int. Cl. G06F 9/44

(52) U.S. Cl. 717/108; 717/143

(57) ABSTRACT

Methods, techniques, and systems for providing project scopes as super-ordinate instances of computer applications projects are provided. Example embodiments provide a method wherein the computer applications are developed based on configuration files of a domain specific language pertaining to calculation tasks. In one embodiment, a “Scope of Resources” class is provided at design phase time. The class defines instances of resources that can be assigned in specific projects. Each project is associated with at least one scope. A project scope is automatically generated when a project is created. The association of resources to scopes and projects is performed during execution of the configured application. In addition to providing pre-configured values and attributes for projects, a scope also provides an aggregation level that is higher than the project level. Accordingly, aggregation analysis can be performed on elements and resources of several projects in their aggregation or taking into account eventual interdependencies.

### TECHNICAL FIELD

The present disclosure relates to methods, techniques, and systems for providing computer application projects and, in particular, to providing computer application projects with scopes as super-ordinate instances of computer application projects, wherein the computer applications are developed based on configuration files of a domain specific language.

### BACKGROUND

When developing, i.e., programming, extensive computer applications in terms of projects, developers have to cope with a high level of complexity and still have conform to the requirement of securing a high level of quality in terms of the reliability of the software program that is developed. This is in particular the case when respective applications are used for critical purposes or in critical environments. Because of that, programming applications induces significant efforts and therefore costs, since in order to cope with the complexity and to ensure the quality of critical applications, a lot of time has to be invested by software programming experts not only for the programming itself but also for testing and quality assurance.

As the programming of a computer application for a given context or problem domain therefore reflects a significant investment, a natural motivation occurs to transfer at least parts of a program coded for one domain to another domain or context. This transfer can generally be called “reuse.” One way to perform this kind of resource reuse in order to reduce the effort needed to code a new application for a different context is to “cut & paste” code from one program to another. However using this method is known to be failure-prone and thus reduces the effort for coding but may well serve to significantly increase the needed effort for quality assurance.

Therefore, in order to support the consistency and quality of programming and to further enable the reuse of pieces of functionality that have been developed in the past, various methods have been developed to provide software developing environments that enable software programming in an abstract way.

One of these known methods is object-oriented programming. Common functionality can here be factored out into objects that are supplemented with defined interfaces for accessing the functionality. Thereby, interoperability is facilitated since the objects can interact on the basis of these described interfaces. The level of abstraction and programming can be heightened as ideally objects can be routed in a specific problem domain, i.e., the knowledge domain of the problem to be solved by the to-be-developed application. In that case, the level of abstraction that is used for programming is not simply the “computer domain,” but rather a more specific, problem-oriented domain or rather a more abstract, i.e., non-technical, domain.

While these methods allow for factoring out functionality into objects and bundling it into common libraries and utility classes, a more structured way of using object-oriented programming principles can be provided by incorporating framework based methods. In this case, common functionality is aggregated into a framework that provides the common functionality, but in addition also serves as an infrastructure for a working program.

Nevertheless, all of these and similar known methods have in common that they make use of the principle of inheritance by which variances can be controlled. Using the inheritance principle, any change applied to a parent object is inherited to the respective child object. This inheritance principle, however, creates significant burden when upgrading the developed application and, in particular, when creating program variance or in a case in which initially developed software is intended to be reused in a new problem context.

In these cases, at least part of the programming has to be redone or at least checked every time the pieces of functionality change. This makes upgrading or transferring programmed applications complicated and expensive. Furthermore, although the major part of the code may be generated by, for example, the framework, at least some code fragments adding functionality and in particular describing how the different modules of the framework should work together still need to be developed from scratch. Therefore, a system-wide quality level cannot be guaranteed on the basis of quality checks of the framework only. Instead a whole system check has to be performed, which again is complicated and expensive.

These example highlighted drawbacks of the known methods illustrate that developing applications still is a relatively expensive and complex effort. In particular, this is especially true in cases where the application is significantly complex and a high level of quality is needed, perhaps due to the criticality of the domain the software is supporting. Furthermore, these methods do not even allow the transferring f knowledge pre-coded in a project that has been done in a particular problem domain to another project in that same domain.

As outlined above, some of the problems that were solved in such a “preceding” project, i.e., the programming code developed in that project, can be transferred (leveraged, or re-used) when factored out into a framework for developing other projects. Nevertheless, a complete software development cycle still has to be performed in order to ensure the quality level in the succeeding projects, as the framework itself cannot guarantee quality.

### BRIEF DESCRIPTION OF THE DRAWINGS

FIG. 1 schematically illustrates an example computing system configured for developing and executing an example computer application in accordance with the present disclosure.

FIG. 2 illustrates an exemplary configuration file and example graphical user interfaces of an example computer application generated based thereupon.

FIG. 3 schematically shows the different phases of computer application development with respect to resource assignment.

FIG. 4 provides a schematic overview of an example computing system used to implement the phases of application development.

FIG. 5 schematically shows the configuration of computer application projects within project scopes.

FIG. 6 illustrates a static structure of the classes of a program translator engine that generates a configuration object from a given configuration file.

FIGS. 7A and 7B show a sequence diagram that illustrates processing of a configured calculation.

FIG. 8 is an example flow diagram of the process for software application development and application execution according to the presented techniques.

### DETAILED DESCRIPTION

Embodiments described herein provide enhanced computer- and network-based methods, techniques, and systems for developing software applications that allow transferring domain-specific knowledge from one project into another without the need to perform new program development cycles or quality assurance routines. Example embodiments provide a method for developing a computer application that is configured to perform calculation tasks based on the configuration of calculation objects that use a domain-specific language. The method provides a domain-specific language that defines syntax for the configuration of calculation objects, wherein each element of the syntax has assigned generalized functionality. Moreover, the method provides a set of configuration classes that define an abstract object model that implements the generalized functionality of the domain-specific language. In addition, the method provides a translation engine, for example a parser, configured to translate the domain-specific language into the object model. Thereby, to develop the application, it is sufficient to create one or more configuration files (strings, or equivalent) that use the domain-specific language, wherein the configuration file at least comprises the declaration of a set of variables, a set of resources and a structure for each of the resources. These configuration files then are then read and translated into objects according the object model and the configuration specified. Thereafter, the translated objects are used to generate a computer application, which presents a graphical user interface and performs calculations tasks upon user input as defined in the configuration files.

As the development of an application for a specific project in the problem domain described by the domain-specific language is reduced to the creating of a configuration file that uses the defined syntax, the effort to create a customer-specific application is dramatically reduced. In particular, the creation of a configuration file needs significantly less effort as for example compared to an actual programming task. Even further, as the configuration files are translated into a predefined object model, the quality of the application can be controlled at the level of the object model and a syntax check of the configuration files, which significantly lowers the effort for ensuring the reliability of the to-be-developed application.

Traditionally (in applying known ways of object-oriented programming principles), objects of the problem domain, for example types of resources, are modelled as independent classes. Example embodiments of the enhanced method, in contrast, provide techniques that allow for creating such objects, as for example resources, as a configured instance of the generalized object class that is created in a purely declarative way.

With respect to objects, like resources used for performing calculations, the enhanced methods, systems, and techniques benefit from an insight that the types of resources used to create a calculation oriented software application differ from each other only in project-specific attributes that, for example, are due to differences of the user contexts, parameters relevant to the calculation, and of course the calculation algorithms used. However, in order to reduce the effort needed for creating a product-specific software application, the enhanced methods, systems, and techniques reduce the specific development efforts to a larger part on these aspects so that the differences are made explicit, for example by the declaration of calculation schemes, but the generalized domain-specific model is mapped into the generalized object model.

Therefore, in example embodiments, the declaration of the structure of a resource comprises the declaration of a resource signature, the resource signature determining the attributes of the resource and calculation schemes used by the resource. Further, the declaration of the structure of a resource comprises an association of the resource assigning other resources as sub-resources to that resource, i.e., the declaration of the resource assignment.

Moreover, in at least one example embodiment, the generalized functionality provides for the generating of a graphical user interface and the performing of calculation tasks upon user input wherein the generating and performing depends on the configuration of calculation objects.

Also, in at least one example embodiment, the declaration of a set of variables comprises the declaration of quantity variables, the quantity variables expressing the consumption of resources and/or the declaration of calculation variables, the calculation variables for specifying a result of a calculation or a parameter of a calculation.

Further, in at least one example embodiment, the declaration of the structure of a resource comprises the declaration of the resource signature, the resource signature at least comprising a quantity variable, the quantity variable expressing the consumption of that resource and being declared in the set of variables, an element as parent resource consuming the resource as a child resource, and a calculation scheme for calculating the amount of the quantity variable caused by the consumption.

In at least one example embodiment, the translation of the configuration file further comprises the reading of the configuration file, the generating of the variable dependency determining the interdependency of the calculation variables defined in the resource signature and the generating of an aggregator for summing up any calculation variables based on the values of the caused (provided) variables of the child resources.

Also, in at least one example embodiment, a computer-readable medium is provided having stored thereon contents, for example, computer-readable instructions that, when executed on a computer, are configured for performing the actions of any of the above described techniques. The computer-readable medium may be, for example, a computer-readable memory means communicatively coupled to a computer system, which stores the computer-readable instructions. In other example embodiments, the computer-readable medium may include for example, computer-readable transmission mediums, including wireless-based and wired/cable-based mediums which store and/or transmit signals containing computer-readable instructions for performing the actions of any of the above described techniques.

Further, the above-described techniques may also be implemented by a computing system prepared for executing a computer application, the computer application configured for performing calculation tasks based on the configuration of configuration objects using a domain-specific language, wherein the computing system is further configured to provide access to a set of configuration classes that define an abstract object model implementing a generalized functionality of a domain-specific language, the domain-specific language defining a syntax for the configuration of calculation objects, where each element of the syntax has assigned generalized functionality. Moreover, the computing system comprises a translation engine, for example, a parser or parse engine that is configured for translating the domain-specific language into the abstract object model. Further, the computing system is configured to provide access to one or more configuration files using the domain-specific language, the configuration files at least comprising the declaration of a set of variables, a set of resources, and the structure of each resource. The computing system also comprises a processing unit that generates, after the translation of the configuration files, a computing application that presents a graphical user interface and performs one or more calculation tasks upon user input as defined in the configuration files.

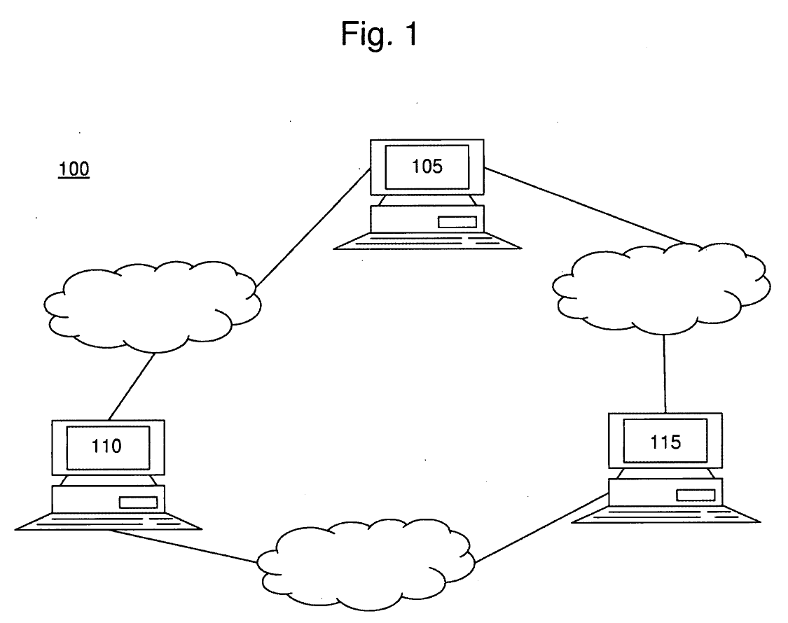

FIG. 1 schematically illustrates an example computing system configured for developing and executing an example computer application in accordance with the present disclosure. The computing system 100 may consist of the three computer systems 105, 110 and 115 (computers). The number of computers shown, however, is only illustrative and can vary in different embodiments. In particular, the computing system may be implemented in a single computer or using multiple homogeneous or heterogeneous computers. The computers 105, 110, 115 are computer systems configured according to known techniques and can, in particular, be mobile computers systems, personal digital assistants (PDAs), wireless or wired devices, or the like. Any computing device configured to perform or execute tasks defined by computer-readable program code or other content can be used to implement the computers 105, 110, 115 illustrated by FIG. 1.

In an example embodiment, the computers 105, 110, and/or 115 may be implemented on general purpose or special purpose computers or computing systems. These computing systems or their components and/or functions may be implemented in software, hardware, firmware, or in some combination to achieve the capabilities described herein. One or more of them may include one or more central processing units (CPUs), input/output (I/O) devices, memory or other computer-readable media, and one or more network connections.

Also, some or all of the components may be implemented or provided in other manners, such as at least partially in firmware and/or hardware, including, but not limited to one ore more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc.

Some or all of the system components and/or data structures may also be stored as contents (e.g., as executable or other machine-readable software instructions or structured data) on a computer-readable medium such as a hard disk; a memory; a network; or a portable media article to be read by an appropriate drive or via an appropriate connection. Some or all of the system components and data structures may also be stored and/or transmitted as contents of generated data signals (e.g., by being encoded as part of a carrier wave or otherwise included as part of an analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

FIG. 1 shows the different computers 105, 110, 115 of computing system 100 interconnected via network connections that in particular embodiments can also be implemented by internet-based connections or other data transmission media.

Furthermore, computer 105, in at least one example embodiment, is the application design environment (or application development) computer system. In that embodiment, computer system 105 provides configuration classes for a domain-specific language (DSL) that implement the intended semantics of the language and that therefore provides the abstract knowledge of the specific domain described by the DSL. Furthermore, computer system 105 provides the domain-specific language itself, which defines, by way of a grammar, the syntax for resource configurations and the definitions for calculation schemes (in configuration files) as described below. Furthermore, the grammar contains program code fragments for each element of the described language. These program code fragments make use of the interfaces of the domain-specific configuration classes. In one embodiment, the program code fragments may be implemented by C# code snippets. In this case, these code snippets use the domain-specific configuration classes as interfaces. Also, computer system 105 provides translation classes that can process configuration files in accordance with described techniques. One embodiment of the translation classes processes concrete resource configurations and calculation schemes defined or declared by way of a configuration file. Accordingly, the translation class contains the program code fragments of the domain-specific language. In one embodiment, the translation classes are C# parser classes that contain C# snippets from the grammar of the domain-specific language.

Computer system 110, in one example embodiment, is the configuration design computer system. In that example embodiment, computer system 110 serves as a design tool that is operated by a user to generate configuration files in accordance with the described techniques. The computer system 110 runs a design application that provides a user with a graphical user interface that enables the user to define and create a configuration file that conforms with the language, grammar and syntax of the domain-specific language provided by computer system 105.

In at least one example embodiment, computer systems 105 and 110 can actually be one and the same computer. In many embodiments, computer system 110 has access at least to the some or more of the elements provided by computer system 105 as described above. In particular, computer system 110 can access the domain-specific language along with its elements. This access may be provided by a network connection, may be implemented via internet-based network connections, or may be provided via a data store contained in computer system 110, for example, through a database that contains the domain-specific language and its elements, or at least a part of the domain-specific language.

The user operating computer system 110 operates a (typically software implemented) design tool that allows the user to generate a configuration file that defines a concrete configuration of resources and calculation schemes using the domain-specific language, i.e., the DSL's grammar and syntax. This configuration file may be stored in a data store in or communicatively coupled to a computer system 110. In some embodiments, the generated configuration file may be transferred to computer system 105 and/or computer system 115.

Within the configuration file, in at least one example embodiment, at least calculation variables and quantity variables are declared. The following example illustrates this kind of configuration in an exemplary implementation:

```
VariableDeclaration
{
  QuantityVariable NumberOfUnits, Mass;
  QuantityVariable Time;
  CalculationVariable Cost, ManCosts;
  CalculationVariable Price;
  CalculationVariable InvestmentCoast, Capacity,
    PowerRequirement,PowerCostRate, MachineHourRate,
    ManCostContribution;
  ScenarioParameter AbsoluteCostSurcharge,
    PercentalCostSurcharge;
}
```

In the above example, expressions like “VariableDeclaration”, “QuantityVariable” and the like are provided by the DSL while expressions like “Time”, “Cost” and like are configured variables.

Further, resource types and their structures are declared in a configuration file according to the principles described herein. The following example illustrates this kind of configuration in an exemplary embodiment:

```
SignatureDeclaration
{
  ElementSignature Part, Module;
  ResourceSignature Substance;
  ResourceSignature Device;
}
```

In this example, expressions such as “SignatureDeclaration,” “ElementSignature,” and the like are provided by the DSL, while expressions such as “Part”, “Device,” etc. are configured resources.

To configure the “behavior” of a resource, its structure is defined, which is achieved in a configuration file by configuring the signature definition of the given resource. This comprises defining the variables of a given resource, as well as defining calculation schemes that provides the values of these variables. The following example illustrates this kind of configuration in an exemplary embodiment:

```
SignatureDefinition
{
  ElementSignature Part
    QuantityVariable NumberOfUnits
    Provides Mass = SUM(Mass);
    Provides MEK = SUM(MEK) + AbsoluteMEKSurcharge;
    Provides FEK = SUM (FEKContribution) + SUM
      (FEK);
  ElementSignature Module
    QuantityVariable NumberOfUnits
    Provides Mass = SUM(Mass);
    Provides MEK = SUM(MEK) + AbsoluteMEKSurcharge;
    Provides FEK = SUM(FEKContribution) + SUM(FEK);
  ResourceSignature Substance
    QuantityVariable Mass
    Parameter Price
    Provides MEK = Price(1 + PercentalMEKSurcharge)
    +
    AbsoluteMEKSurcharge;
  ResourceSignature Device
    QuantityVariable Time
    Parameter InvestmentCost
    Parameter Capacity
    Parameter PowerRequirement
    Parameter PowerCostRate
    Provides MachineHourRate =
      (InvestmentCost/Capacity) + (PowerRequirement
      * PowercostRate);
    Provides FEKcontribution = MachineHourRate;
  }
```

In this example, expressions such as “SignatureDefinition,” “ElementSignature,” “ResourceSignature,” etc. are provided by the DSL while expressions like “Part,” “Device,” etc. are configuration inputs.

In an example embodiment, the configuration file, created typically by a user on computer system 110 is then translated using the translation classes, e.g., using the C# parser classes defined on computer system 105. This translation results in the creation of translation objects, which, in at least one embodiment, are created as C# parser objects. Therefore, in at least one embodiment, the configuration file is parsed using the C# parser classes and instances of the parser classes are created as C# parser objects.

In FIG. 1, computer system 115 is responsible for executing the application designed by way of the configuration file that encompasses the domain-specific language. In at least one embodiment, computer systems 115 and 110 or 115 and 105 may actually be the same computer.

Computer system 115, by using network connections, by accessing a data store contained in or communicatively coupled to computer system 115, or by accessing an alternative data storage, has access to the translation objects (e.g., C# parser objects) created by translating the configuration file using the translation classes (e.g., C# parser classes) using computer system 110.

At run time, for example, at server start, the program code fragments in the translation objects are executed to instantiate configuration objects in accordance with the concrete configuration files that were created using computer system 110. In one example embodiment, computer system 115 has access to the translation (C# parser) objects and thus at run time—in the example embodiment at server start—the C# snippets in the parser objects are executed. The configuration objects instantiated by executing these translation objects provide a singleton object graph that provides instances of the configuration classes which represent exactly the information in the configuration file. Further, they may contain calculator objects, for example aggregators, which can calculate the values of all calculation variables for all resource types according to the calculation schemes defined or declared in the configuration file.

Resource objects may be also instantiated as part of the process of executing the translation object program code fragments against the concrete configuration file. (As described further below, resource signature definitions used to assist in defining and instantiating resources may be included as part of a configuration file.) These resource objects may use other configuration objects, such as calculator objects, to calculate values for configured calculation variables in particular by using the calculator objects that correspond to the calculation variable types. (Calculator objects are described further below.) Moreover, using the configuration objects, a graphical user interface automatically may be generated to assist the user, for example, in tasks like constructing actual resources and filling in parameters, for example in projects or during administration of the application. A project here refers to a project for developing one or more computer applications. Further, reporting services may make use of the configuration and resource objects to request values for calculation variables according to the definitions declared in the configuration objects. Thus, using the configuration objects, a graphical user interface can be generated and presented to the user of computer system 115 at run time that enables the user to perform, for example, the calculation tasks and/or other application services, such as the reporting services.

Therefore, computing system 100 supports a pure declarative way of developing an application. All definitions of calculation algorithms, including the calculation schemes (schemata), are done in a declarative way and are described in a specific formal language, in particular a domain-specific language. Therefore, according to the described techniques, the logic of the program code of a particular application depends on the explicit description of resources, which is done in a declarative way, as it is configured in a configuration file.

Using this technique for developing a computer application not only reduces the efforts needed for actual programming, but also enhances the performance of calculation tasks. In particular, because the application is generated at run time, only those elements or resources that are truly necessary, according to the declared calculation logic, are calculated and/or allocated.

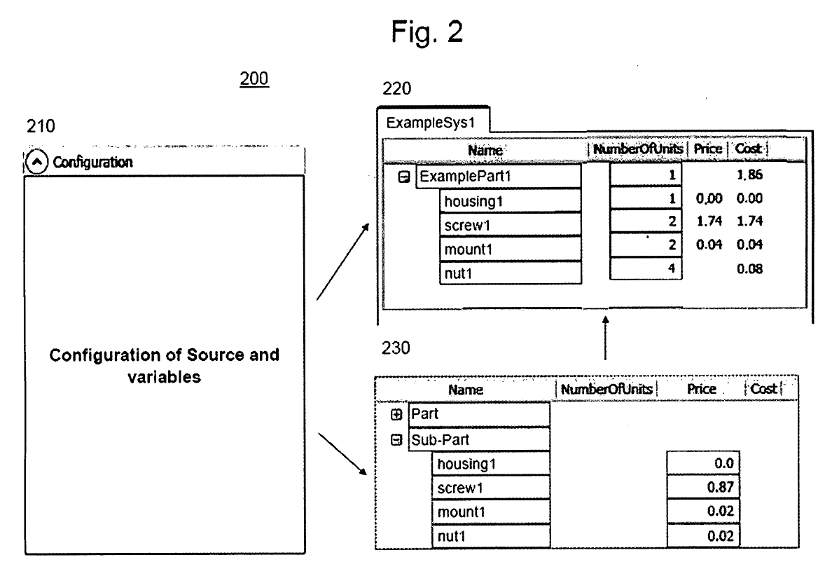

FIG. 2 illustrates an exemplary configuration file and example graphical user interfaces of an example computer application generated based thereupon. The computer application 200 may be developed based on the programming environments provided by, for example, the computer system 105 described within the context of FIG. 1.

Specifically, FIG. 2 shows an exemplary configuration file 210 that is used to generate user interfaces 220 and 230 of an example application 200. In one example embodiment, the configuration file 210 is generated using the principles described herein, including that it is based on the domain-specific language provided by language design computer, e.g., computer system 105. The configuration file 210 uses the elements of the domain-specific language, its grammar and syntax. The configuration file 210 describes calculation schemes (e.g., a simple equation, for example, “provides cost=price”) and declares and configures resource objects by way of signature declarations and signature definitions. Thus, configuration file 210 configures an application through declaration source and variables.

The use of configuration file 210 illustrates that, based on the principles and the techniques described herein, the effort for creating a computer application can be dramatically reduced. Further, project-specific customizations that may be needed in order to meet the requirements of a specific problem domain can be fulfilled without the need for extensive programming or coding tasks and without the need for full software quality processes, because a major part of the quality assurance can be provided based on the quality of the development environment itself.

In particular, configuration file 210 shows that, for developing a computer application according to the principles described herein, variable declarations and declarative descriptions of resource types (i.e., calculation objects) and calculation algorithms (i.e., calculation schemes) may be sufficient to implement an application. For example, when applied in a manufacturing business context, the calculation objects may be defined for Parts, Assemblies, or a Machine. Other domains may provide different calculation objects or other resources.

As shown in this example, the programming environment provided by computer system 105 provides, by way of the configuration classes and the domain-specific language, the form (and structure) of the resource types that can be used in a specific domain and the form of the calculation algorithms that can be used to create a specific configuration. Application development can then be reduced to a declarative description of resources and to a description of resources and calculation algorithms (defined for that domain). These resources and calculation algorithms are then instantiated as objects at run time and executed using the program language translation classes provided by computer system 105.

These concepts are illustrated in FIG. 2 by the graphical user interfaces 220 and 230 of a computer application 200, which are generated and completely determined based on the configuration file 210. In other words, using the application design environment provided by computer system 105, based on the configuration file 210, a computer application 200 is generated at run time that provides graphical user interfaces 220 and 230. Therefore, any calculation can be configured for any object using (and compliant with) the grammar and syntax of the respective domain-specific language, and, based on that configuration, a computer application can be generated at run time that changes the functionality and appearance of its graphical user interfaces as determined by the configuration file 210.

As an example, a configuration file 210 may declare different kinds of elements, e.g., Parts and Sub-Parts. In the signature definition, these elements are defined in terms of their attributes, which here include various quantity and calculation variables. Thus, to support the signature definitions, various variable types have been previously declared, e.g. quantity variables and calculation variables. For example, a quantity variable of “Number of Units” was previously declared. Also, calculation variables representing “Price” and “Cost” were previously declared. These variables are intended to serve as illustrative examples. and other variables or variable types, in particular additional or different variables and variable types, could be declared according to the principles described here.

The signature definition for any declared element, e.g. an element “Part,” configures how it will be consumed by others (other elements/resources that include it as a sub-resource) through the elements' associated quantity variable(s) (e.g., a “number of units” variable associated with each “Part”). Furthermore, for any declared element, calculation schemes may be defined based upon declared calculation variables. For example, a variable reflecting costs could be declared for an element, which could for example be calculated as a sum of the costs of resources/elements that are assigned to the respective element (e.g., a cost variable for each element “Part” may be computed based upon the sum of the costs of the Sub-Parts” assigned to each “Part”). Thus, other elements/resources may be assigned as sub-resources to other elements/resources.

For some elements, e.g. an element “Sub-Part” in user interface 230, the consumption of the resource may be declared using quantity variables whose values are entered later, for example, by a user. Also, in the signature definition for such elements, one or more parameters could be associated with the respective elements that require additional input by a later user of the generated application (e.g., a parameter reflecting the price of a unit of that element could also be declared). The configuration file could then define that the cost consumption of that element is to be calculated on the basis of the inputted price. This example is merely illustrative of a configuration that could be used to generate the application 220/230. According to the principles described herein, alternative or additional ways of configuration also could be used to achieve the same result.

For example, in the graphical user interface 230 shown in FIG. 2, a user may input Sub-Parts as configured by configuration file 210. In particular, in this example, the user has input four different Sub-Parts with their specific configured parameter (calculation variable), namely “Price.” Further, as shown in the graphical user interface 220, the example part “ExamplePart1” makes use of all of the four defined Sub-Parts and, again based on user input, the number of units “consumed” by the Part “ExamplePart1” is defined in different quantities according to the quantity variable configured for each Sub-Part element in configuration file 210. For each line (Sub-Parts of the Part), the execution of the configured calculation scheme is shown. Specifically, for each Sub-Part that is “consumed” by (used in) the Part, its respective Cost is calculated based on its Price and the costs for the indicated number of Sub-Parts is aggregated to the sum of costs of the Part (namely, 1.86).

This configuration easily could be changed by, for example, changing the configuration of the cost calculation of the element “Sub-Part.” For example, one could configure that the cost for each Part is to be two-times the price. Accordingly, the graphical user interface would change automatically and the calculation of the costs would change as well.

Further, this technique for developing an application could be used in other domains, for example for calculating the costs of a service. For example, instead of Parts and Sub-Parts, the elements Task and SummaryTask and a resource Service Engineer could be configured in a configuration file. In such an example, the cost of the consumption of an service engineer's time could be calculated as hourly rate, and then aggregated across tasks. Accordingly, any calculation on any object could be similarly configured to that described with reference to FIG. 2 to generate a respective application.

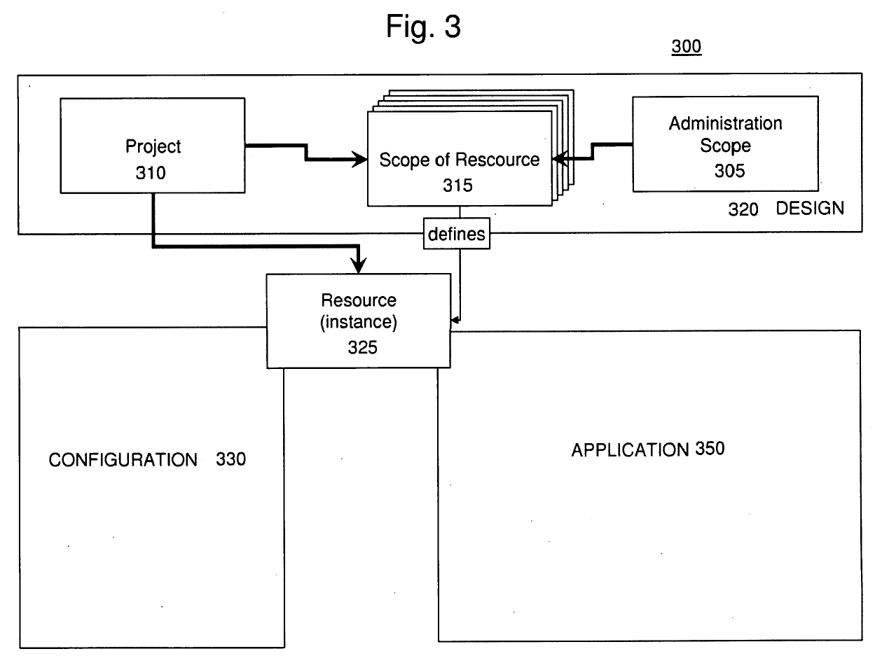

FIG. 3 schematically shows the different phases of computer application development with respect to resource assignment. Resource assignment represents the association of a specified amount of resource A (“sub-resource”) to a resource B (“parent-resource”). In this sense, A could also be referred to as a “provider” resource and B could be referred to as a “consumer” resource. Depending upon the specific character of A and B, A and/or B could also be elements instead of resources.

According to the described techniques, a resource is an entity which “causes” or provides values of a configured calculation variable when a particular amount of that resource is “consumed” as defined by a corresponding resource association. A resource is defined by its signature as defined in a configuration file, e.g., configuration file 210. In the syntax of a configuration file, a resource is defined within a signature definition. In addition to the signature, to fully define a resource, an assignment of the resource is determined which associates sub-resources to a given other resource. In a configuration file, this is achieved by defining the other elements/resources that could be consumers of a given element/resource.

Therefore, in one sense, a resource is a calculation variable provider. This means that calculation variables can have different values for each resource. The particular calculation variables that are provided values by a specific resource are configured by the signature of the respective resource in a configuration file, for example, configuration file 210.

In one example embodiment, elements are differentiated from resources that are “natural resources.” In such an embodiment, elements are treated as special resources because they are referred to in or, for example, make up a bill of materials, in CAD applications, reporting systems, etc. Moreover, in such an embodiment, the elements represent products or collections of products to be sold or types of such products. In contrast, in such an embodiment, semi-finished parts may not qualify as elements, for example, as they would not be capable of being sold. Thus, in such embodiments, elements would be differentiated because they implement functions over a product. Alternatively, in this embodiment, attributes could be defined as resources or resource instances.

Computer application development 300 according to the techniques described herein is performed in different phases. In the design phase 320 of the application development 300, generalized classes of resources are provided. The design phase 320 may thus serve as the application design environment provided by computer system 105. Thus, the elements provided within the design phase 320 are provided on an abstract basis for application development in the sense of the configuration classes and domain-specific language as described within the context of FIG. 1.

Moreover, at the design phase 320, a class referred to as “scope of resources” or “scopes” 315 is provided. The scope of resources class 315 determines the logical area in which resources can be defined for a specific project 310. In other words, the scopes 315 of design phase 320 defines instances of resources 325 that can be assigned in specific projects 310. However, the actual association of resources to scopes 315 and projects 325 is done during run-time, more specifically during execution of application 350.

In one example embodiment, several scopes of resources classes 315 are provided. In this embodiment, one of these scopes 315 is an administration scope 305. The administration scope 305—as a specific resource scope 315—comprises resource types which provide “templates” of specific resources 325. Resource types can therefore not be directly allocated. Instead, in that embodiment, other scopes 315, i.e., scopes 315 that are not the administration scope 305, provide instances of resources 325 as an instance of a version of a resource type defined in the administration scope 305. Accordingly, resources 325 can also be versioned.

Based on this behavior, resources 325 support not only versioning but also reference copy behavior. In particular, resources 325 may have a reference copy relationship. In that sense, resource instances 325 in any scope 315 (except for the administration scope 305) reference resource types in the administration scope 305 as reference copies of the (template or original) resource type. Further, a resource instance 325 of one scope 315 can reference resources instances of another scope 315 as long as that second scope (i.e., the scope from which resource instances are referenced) is a super-ordinate scope (in terms of a “parent”-scope) of the first scope. Based on this reference copy behavior, versioning of resources 325 is provided in that a reference copy of a resource refers to (potentially) a more “specialized” version of the (“original”) resource.

The following listing provides an illustrative example of the logical definitions which are provided in design phase 320 in context of scopes:

```
resourceConfiguration returns [IResourceConfiguration·result]
scope {IResourceConfiguration·rc ;}
@init
{
  result = $resourceConfiguration ::rc;
}
:
  (quantityVariableDeclaration )+
  (calculationVariableDeclaration )*
  (elementDeclaration )+
  (resourceDeclaration )+
resourceDefinition )*
;
...
calculationVariableDeclaration
:
‘declarecalculationvariable ’
  (
id = calculationVariableIdentifier
{
  ICalculationVariable·v =
      $resourceConfiguration ::rc.CalculationFactory
      .CalculationVariable (id); $resourceConfiguration
      ::rc.DeclaredCVs .Add (id,·v);
}
)+
‘; ’
;
```

For a specific configuration 330, i.e., for the development of a specific application, resources as elements and the associations between the resources/elements (i.e., the element/resource assignment) are defined. An example of this configuration is shown in configuration file 210 and could be executed on a configuration computer system 110 as described in FIG. 1.

At run time, an application 350 is generated, which instantiates the resources as defined by the configured elements/resources in the configuration 330. The configured elements/resources also provide the element/resource assignments. Thereafter, within the generated graphical user interfaces (e.g., user interfaces 220, 230), the instantiated resource objects are provided and the calculations are performed according to the configured assignments, thus determining the associations between the various elements/resources.

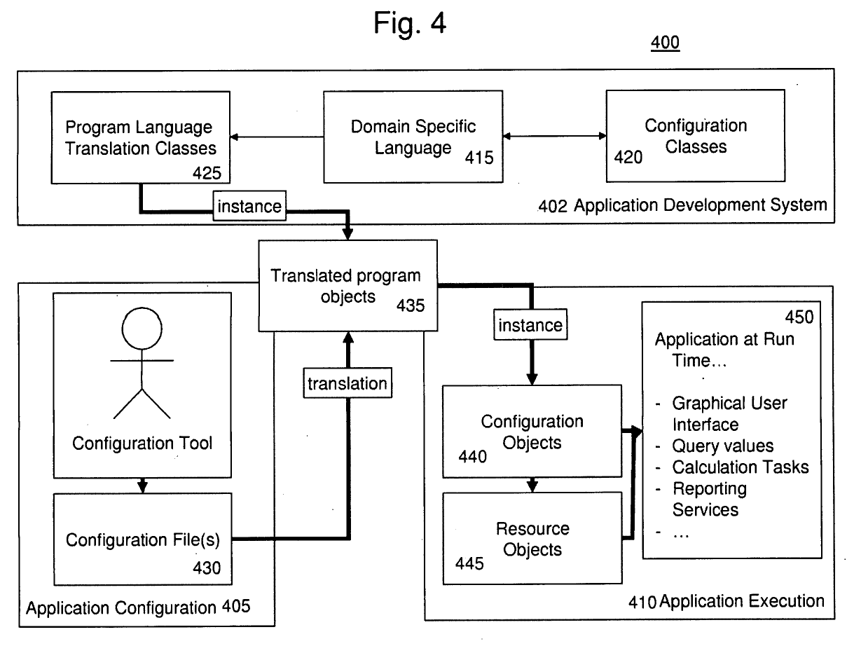

FIG. 4 provides a schematic overview of an example computing system used to implement the phases of application development. Example computing system 400 shows the different levels or phases of the application development process described with reference to the tasks of FIG. 3. In particular, FIG. 4 shows the application development 402, application configuration 405 and the application execution 410.

As described with reference to FIG. 1, application development 402 may be provided by computer system 105, configuration 405 may be performed on computer system 110 and application execution 410 may be done on computer system 115. Also, as mentioned in FIG. 1, one or more of these computing systems 105, 110, and/or 115 may be the same computing system. The application development system 402 specifies the parameters which may comprise the objects (resources, calculation algorithms) and provides a general description of these parameters as meta data. These specifications are codified within a domain-specific language 415.

The domain-specific language 415 as mentioned is a formal language that defines the specification, configuration, and calculation schemes needed for project-specific application development. Therefore, the domain-specific language 415 describes the basic structure of calculation objects and their calculation algorithms. The semantics of an domain-specific language 415 is implemented as an abstract object model, namely the configuration classes 420. Further, application development system 402 provides program language translation classes 425 that translate the domain-specific language 415 into the object model (classes 420). The program translation classes 425 allow configuration files 430 generated according to the domain-specific language 415 to be translated into executable program code. In one example embodiment, the program language translation classes 425 are C# Parser classes whereby a parser or compiler is generated that is able to interpret the domain-specific language 415. Thus, using the application development system 402, an abstract calculation application can be implemented that changes in behavior, calculation, graphical user interface, and so on according to a given configuration, e.g. as defined by a configuration file, for example configuration file 210. This change according to the configuration file is reflected in the object model (classes 420).

To configure an application using the designed objects, a user uses the application configuration system 405, performed for example on computer system 110, using a configuration tool, for example, to generate configuration files 430. A user uses the configuration tool to configure objects (within the configuration file 430) that have been predefined using the domain-specific language 415 of the application development system 402. Therefore, the configured objects relate to a specific problem domain as shown in, for example, FIG. 2, which illustrates example objects of a domain of calculation tasks.

A specific advantage lies in the fact that only those objects from the various object types provided by application development system 402 are configured that are specifically needed for a particular application; that is, objects that are not needed are not configured, and are therefore not instantiated during run time. This leads to significantly improved application performance since only those elements and resources are calculated during run time that, according to the configured calculation logic, are necessary to be calculated. As a consequence, potentially only a small part of a full project is calculated and only data that corresponds to the calculated part has to be retrieved from an associated data store. Thus, using application configuration 405, the user may make use of desired ones of the numerous object types provided by the application development system 402 by configuring only those objects that are needed for a specific application.

In one example embodiment, the configuration files 430 provide the aggregation of all customizing and/or configuration data for an application developed according to the techniques presented herein. In particular, configuration files 430 contain the configuration of all resources which are existent in the project and their calculation attributes and other attributes as well as any needed calculation schemes. Furthermore, configuration files 430 provide a resource “signature,” as demonstrated with respect to FIG. 2. The resource signature is a part of the resource configuration and defines all attributes and calculation schemes of a given resource type. A resource signature can have various elements. The elements described with reference to FIG. 2 therefore serve as illustrative examples and other, in particular further elements could be used according to the techniques of the present disclosure.

In example embodiments, the domain-specific language 415 may provide the ability to configure calculation variables. A calculation variable is an identifier that represents a value which is of interest for calculation purposes, for example for calculating production costs. Unambiguousness for calculation variables is ensured by the grammar and syntax of the particular domain-specific language 415. The value of a calculation variable is provided by a calculation variable value provider. That means that one and the same calculation variable can have different values as provided from different calculation variable value providers. For example, production costs can be calculated as [symbol] 2 for a Module A and can be calculated as [symbol] 3 for a Module B.

The domain-specific language 415 also provides the ability to configure quantity variables, which provide for the calculation of the consumption of a specific amount of a given resource. Using these and the above-described elements of a domain-specific language configuration, a “context” can be provided that provides a resource configuration for a given program installation in a specific project. It is to be noted that the list of elements of a resource signature described herein is rather illustrative. Other embodiments may provide other, different, or more specific elements that may be declared in a resource configuration.

In addition to the elements provided by the application development system 402 that are used within application configuration 405, the application development system 402 provides other objects.

In particular, as already indicated above, the application development system 402 provides calculation variable providers that provide values for a specific calculation variable. In an example embodiment, these calculation variable value providers can be resources or based upon the resulting associations between resources. Thus, a calculation variable may be given a value by a given calculation variable value provider, for example, by a given resource.

Further, the application development system 402 provides dictionary value providers that store values of any calculation variable in a dictionary.

In addition, application development system 402 provides calculators that calculate the value of a calculation variable according to the values of other calculation variables provided by a given calculation variable value provider. A calculator does not have to have any knowledge about which specific calculation variable is currently being calculated. However, a calculator does have knowledge about the calculation variables from which values are needed in order to perform the given calculation. These needed calculation variables can also be called the dependencies of the given calculator. Therefore, to obtain the result of a calculator, a calculation variable provider has to be provided to the calculator that in turn can provide values for all of the calculator's dependencies. Nevertheless, the calculator does not implement a specific calculation algorithm as the calculation algorithm itself is defined by declaration in the application configuration 405.

Thus, in order to perform a given calculation task, dependencies are relevant. Variable dependency is therefore an explicit definition of the dependencies between the calculation variables of a resource signature. These dependencies are defined during application configuration 405 time and in particular in configuration files 430. Thus, these dependencies do not change at run time or during application execution. Variable dependency is used for determining the sequence of a calculation. In one embodiment, explicit representation of the dependencies is used to perform optimization, so that each recursive variable is calculated without depending upon recursion. Using this technique, the calculation of the hierarchy of elements is run through only once as highlighted by the following example:

```
P1, P2 are parameters
calculation scheme local: V1 = P1, V2= V1 + P2
calculation scheme recursive: V3 = sum over all the
        three of the child resources + V2
dependencies:
- P1: { }
- P2: { }
- V1: {P1}
  - V2: {P1, P2, V1}
- V3: {P1, P2, V1, V2} + V3 at all child resources
```

When at run time a specific request for a resource or a resource application is generated, for example a request for a list of values for certain calculation variables, then a variable dependency projection is generated based on the variable dependency of the given resource signature on the list of variables. This variable dependency projection provides a projection of the variable dependency on the list of variables. The variable dependency projection explicitly contains the exact dependencies that are necessary for answering the request. With respect to the example highlighted above, the variable dependency projection generated based on a request for P2 and V1 would contain:

| | |
|---|---|
| P2: | [ ] |
| V1: | [P1] |

As can be seen, V2 and V3 are not contained in this dependency projection as their values are irrelevant to respond this request.

Moreover, in some embodiments application development system 402 may provide an expression calculator which interprets an expression, for example “A+B.” For a given expression calculator, the dependencies are therefore those calculation variables configured in the given expression.

In some embodiments the application development system 402 also provides a recursive calculator that encapsulates an algorithm that can aggregate the values of a calculation variable provided by the members of an enumeration of value providers. The recursive calculator can aggregate the values of several calculation variables all at once. For example, two value providers provide a device A and an employee B, respectively, each value provider providing both cost type A and cost type B. The value of cost type A at device A is [symbol] 2 and the value of cost type A at employee B is [symbol] 3. The value of cost type B at device B is [symbol] 5 and the value of cost type B at employee B is [symbol] 7. The aggregator aggregates in a single recursion as follows: cost type A are [symbol] 5 and cost type B are [symbol] 12.

Also, the application development system 402 may provide value aggregators that can aggregate lists of values, as for example sums, maximums, minimums, averages, etc.

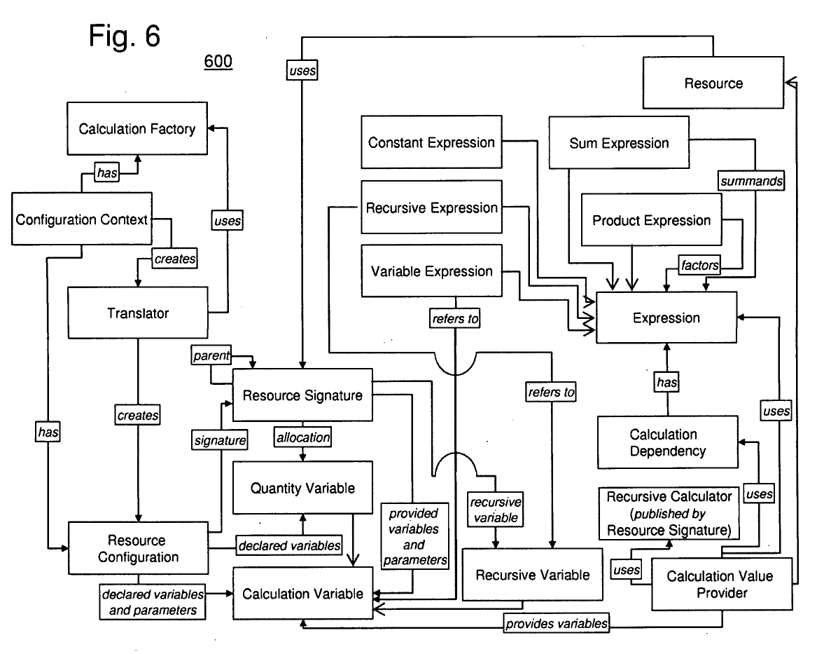

The interrelation of the various elements provided by the application development system 402 as mentioned above are further described with reference to FIG. 6.

Based on the elements provided by the application development system 402, which are configured by application configuration 405, translated computer-program objects 435 (for a specific configuration) are generated. These translated computer-program objects 435 are instances of the program language translation classes 425 that translate a configuration file 430 into program objects. Based on these translated program objects 435, the application can be executed, for example at computer system 115.

For application execution 410, instances of the translated program objects 435 (created by executing code snippets in the program objects with a configuration file) are generated as configuration objects 440. The application at run time 450 uses these configuration objects 440 to generate graphical user interfaces, query values, perform calculation tasks, provide reporting services. and so on. Further, resource objects 445 are instantiated that may use the configuration objects 440 to calculate values for the configured calculation variables using the calculation objects of the configured types.

In order to further illustrate the relation between the generic implementation provided by an application development system 402 and the specific implementation configured during application configuration 405 the following example is provided. In this example, a configuration file 430 is provided which includes in a normal font the elements provided by an application development system 402 and includes in an italic font the definition provided by an application configuration 405:

```
DeclareQuantityVariable Piece Mass;
DeclareCalculationVariable Cost Price;
DeclareElement Part (Piece) Module (Piece);
declareresource Substance (Mass);
Element Part
  provides Mass
    aggregator subresources sum
  provides Cost
    aggregator subresources sum
Element Module
  provides Mass
    aggregator subresources sum
  provides Cost
    aggregator subresources sum
Resource Substance
  parameter Price
  causes Cost = Price
```

The example configuration file shown has a declaration section and an object definition section. The declaration section shows a quantity variable declaration (DeclareQuantityVariable) which provides the two quantity variables “Piece” and “Mass.” Further, it shows a calculation variable declaration (DeclareCalculationVariable) for two calculation variables “Cost” and “Price.” The file also declares “Part (Piece)” and “Module (Piece)” as elements (DeclareElement). This element declaration defines that the consumption value for both Part elements and Module elements is “Piece.” (A resource or element that consumes a Part or Module element will do so in units of “piece.”) Further, a resource “Substance (Mass)” has been declared (DeclareResource). This Substance does not have a element signature as it is a “natural” resource and is thus consumed by its mass.

In the object definition section, a definition for an element called “Part” is provided (“Element Part.”) Using the grammar and syntax of the Domain Specific Language, combinations of elements also could be defined. For example, in one embodiment, an association between parts and assemblies could be declared that would define that Parts could only be assigned to Assemblies. Continuing, the file defines that Parts can be requested for their mass. The mass of a Part is calculated as the sum of the masses of its assigned sub-resources (provides Mass, aggregator subresources sum). The definition also defines that Parts can also be requested for their Cost value; the Cost value is calculated based on the sum of the Cost values of its assigned sub-resources (provides Cost, aggregator subresources sum). Based on this definition, all elements or resources that have the possibility to be associated with or combined in a “Part” could be sub-resources of this element. For example, an element or resource that provides a “Cost” (so that it could be aggregated by the Cost aggregator) could be so associated. The resource Substance could, for example, be defined in such an association by assigning Substances to Parts.

More specifically, the file defines that a Substance has only one parameter, its Price. When a given amount of the Substance resource is assigned, it causes Cost. In this example, the Cost of a Substance is calculated as the price of the Substance (causes Cost=Price). Thus, when a Substance is associated with a Part element, the Cost of the Part is the aggregation of the sum of the cost of the Substance along with the cost of any other sub-resource.

This example shows an exemplary configuration file 430 for a given implementation of a domain-specific language. However, this specific syntax grammar and elements used in this example serve as an illustrative example, and alternative implementations, for example alternative embodiments of a domain-specific language or other domain-specific languages may provide different syntaxes, grammars, elements and/or resources.

This concept may be further illustrated by the following example which provides a configuration for another exemplary implementation of the present disclosure. In the following example configuration, again a normal font is used to indicate the elements provided by an application development system 402 and the italic font is used to indicate the definition provided by an application configuration 405.

```
VariableDeclaration
  {
    QuantityVariable NumberOfUnits, Mass;
    QuantityVariable Time;
    CalculationVariable MEK, FEK;
    CalculationVariable Price;
    CalculationVariable Investment Cost, Capacity,
        PowerRequirement, PowerCostRate, MachineHourRate,
        FEKContribution;
    ScenarioParameter AbsoluteMEKSurcharge,
        PercentalMEKSurcharge;
  }
SignatureDeclaration
  {
    ElementSignature Part, Module;
    ResourceSignature Substance;
    ResourceSignature Device;
  }
SignatureDefinition
  {
    ElementSignature Part
      QuantityVariable NumberOfUnits
      Provides Mass = Sum(Mass);
      Provides MEK = Sum(MEK) + AbsoluteMEKSurcharge;
      Provides FEK = Sum(FEKContribution) + Sum(FEK);
    ElementSignature Module
      QuantityVariable NumberOfUnits
      Provides Mass = Sum(Mass);
      Provides MEK = Sum(MEK) + AbsoluteMEKSurcharge;
      Provides FEK = Sum(FEKContribution) + Sum(FEK);
    ResourceSignature Substance
      QuantityVariable Mass
      Parameter Price
      Provides MEK = Price * (1 + PercentalMEKSurcharge) +
          AbsoluteMEKSurcharge;
    ResourceSignature Device
      QuantityVariable Time
      Parameter InvestmentCost
      Parameter Capacity
      Parameter PowerRequirement
      Parameter PowerCostRate
      Provides MachineHourRate = (Investment Cost /
        Capacity) + (PowerRequirement * PowerCostRate);
      Provides FEKContribution = MachineHourRate;
```

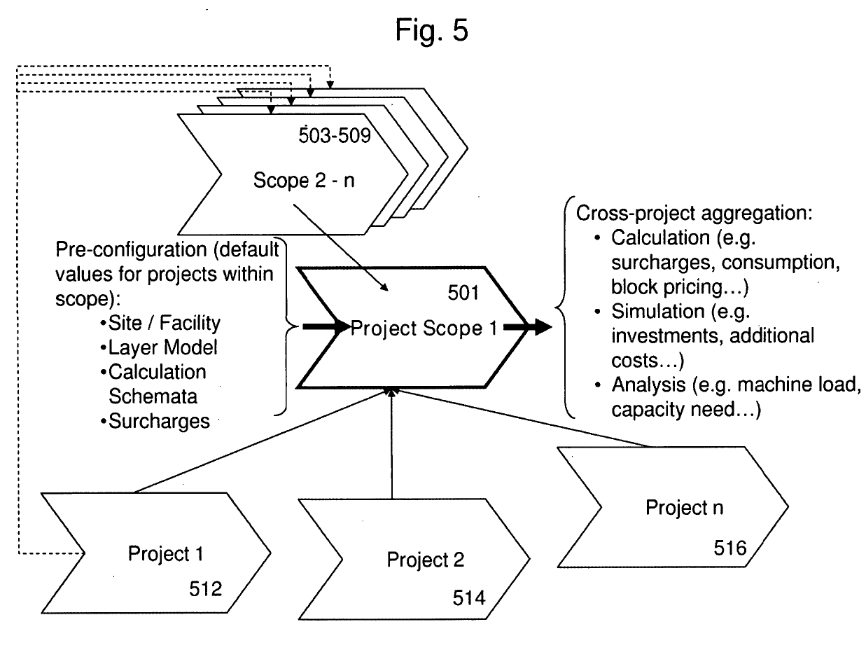

FIG. 5 schematically shows the configuration of computer application projects within project scopes. In particular, computer application projects 512, 514, 516 are associated with project scope 501 and project scopes 503-509. A project scope as described above with reference to FIG. 3 provides the logical area in which resources can be defined for a specific project.

In one example embodiment, scopes 501-509 are associated with projects 512-516. Project scopes 501-509 thus provide superordinate instances to projects 512-516. In one embodiment, each project is associated with one scope 501-509. However, in other embodiments, each project is associated with one or more scopes. For example, the project 512 indicated in FIG. 5 is associated with a number of scopes 501-509. In one embodiment, a project scope is automatically generated when a project is created (for example project scope 501 is automatically generated when project 512 is created). This automatically generated scope may bes interpreted as a “standard” or “default” scope and thus it is typically private, i.e., it cannot be accessed outside of that project.

However, in some embodiments several projects, e.g., projects 512-516 are associated to one scope, e.g., project scope 501. In order to create these associations, the scope 501 has to be published. This publication may include the assignment of a unique identifier to the scope (as indicated in FIG. 5 “project scope 1”). Further, the publishing of a project scope may comprise a hierarchical allocation of the project scope. Thus, project scope 501 could, for example, be hierarchically allocated below project scope 503, as indicated in FIG. 5.

Further, the publication of a project scope 501 and the association of several projects 512-516 within that project scope 501 allows for pre-configuration of default values for all projects 512-516 that are associated to that project scope 501. Accordingly, default values could be determined for all projects 512-516 within a particular project scope 501. In that case, for a specific project 512, any of those values, provided as default values, could still individually be modified.

Pre-configuration of cross-project attributes could also be provided by publication of a project scope 501. For example, cross-project attributes might include the determination of sites or facilities, the definition of a layer model, or the pre-configuration of calculation schemata. These are, however, illustrative examples of pre-configuration of default values or input attributes that could be achieved via the publication of a project scope and other, more alternative and further default values and attributes could be defined according to similar techniques.

For example, costs could be identified or determined that are to be distributed over all projects 512-516 associated with a particular scope 501. In one example embodiment, projects 512-516 are associated to a scope 501 in a hierarchical tree structure, which allows for calculating values such as generating a table that provides the definition of the cost allocation of all costs defined or generated at the scope level.

In addition to providing pre-configured values and attributes for projects 512-516, scope 501 may also provide an aggregation level that is higher than the project level. In particular, at the project scope 501 level, aggregation analysis can be performed on elements and resources of a project 512-516 in their aggregation or taking into account eventual interdependencies.

For example, by aggregating on the project scope level, machine load and capacity needs, further needs for investments and respective additional costs could be identified. Moreover, based on such additional costs, cost allocation could be calculated that allows one to allocate the additional costs/investments to the projects 512-516 associated with a particular project scope 501. Thus, this project scope 501 defines a logical framework in which the elements and resources of any number of projects (associated to that project scope 501) can be taken into account in their entirety, also accounting for any interdependencies.

Accordingly, project scope 501 allows for cross-product, cross-unit, or cross-site calculation, aggregation and analysis of elements and resources in its associated projects 512-516. Thereby, project scopes 501-509 allow for calculations involving entire business units and companies.

In at least one embodiment, the administration of projects 512-516 and scopes 501-509, i.e., the association of a project 512-516 to scopes 501-509 and the hierarchical allocation of scopes 501-509, is provided by the application development design system, e.g., the application development system 402, which provides a graphical user interface that allows users to visualize scopes as a hierarchical tree structure of folders. Note that other visualizations of other types of hierarchies, other than a tree of folders may be similarly employed.

By publishing a project scope 501, within that folder structure the actual project scope 501 is hierarchically allocated such that, for example, scope 501 (“Scope 1”) is published hierarchically under or subordinate to project scope 503 (“Scope 2”) as indicated in FIG. 5. However, this particular configuration of course serves as only an illustrative example. Any other hierarchical allocation would also be possible for project scope 501 according to the present techniques.

In one exemplary embodiment, in conjunction with publication of the project scope, metadata of the project scope is determined. As an example, the metadata of project scope 501 contains a unique identifier, a description, grouped pre-configurations, and a list of cost allocations (“charges” or “surcharges” to its members). These metadata may be activated optionally, i.e., in one embodiment only the activation of a unique identifier might be mandatory and the other metadata might be activated if suitable/applicable. In any case the pre-configuration data, i.e., the list of metadata categories, serves as illustrative examples and other alternative or further metadata for a project scope could be implemented accordingly.

For example, the grouping of default values/attributes may contain information about sites, layer models, and/or calculation schemata. Projects 512-516, which are associated to project scope 501 in the Figure are thus hierarchically allocated below, and thus subordinate to, project scope 501. Therefore, projects 512-516 may assume the default values/attributes of project scope's 501 metadata as input parameters. However, in some embodiments these predefined input parameters are assumed on optionally so that project-specific modification still is allowed.

In one example embodiment, as mentioned, a project scope, such as project scope 501, cannot be created in an explicit way. Rather, in that embodiment, by creating a (new) project 512, the associated (new) scope 501 is automatically generated. Accordingly, a project 512 can only be contained once in any particular scope 501. In other words, while one particular project 512 may be associated to various scopes 501-509, in each of these scopes 501-509 the particular project 512 will only be contained once.

In the graphical representation of a hierarchical folder structure of scopes 501-509, as described above, scope 501 can be hierarchically allocated and moved between different levels of that hierarchy. In that respect, the hierarchical structure also represents projects 512-516 within scopes 501-509 as folders.

In one example embodiment, by “moving” a project folder graphically representing, for example, project 512 to a different level of the folder hierarchy, for example into the folder of a higher allocated scope 503, a new reference to project 512 is added to scope 503 (and potentially deleted from scope 501). In a case in which the folder representing scope 501 is moved to a different level of the folder hierarchy, then the projects 512-516 associated with that scope 501 also are moved to that new folder level, i.e., scope.

Alternatively, in one embodiment, upon user input, instead of moving the project 512 associated with project scope 501 to another scope 503, a new reference to a project 512 can be added to scope 503. In this respect, adding a reference to a particular project 512 to an identified scope 503 is interpreted as a “copy” action. In contrast, moving a project folder representing project 512 or other project 512-516 associated with scope 501 to another folder level or rather scope 503, may being interpreted as a “cut” operation. Other permutations and combinations are also supportable.

Accordingly, the graphical user interface representing a hierarchical structure of project scopes 501-509 and projects 512-516 allows for the adding of projects 512-516, deleting of projects 512-516, copy/paste actions on either projects 512-516 and/or scopes 501-509, as well as for the moving of projects 512-516 to different scopes 501-509 or hierarchical levels.

As these activities may of course have impact on the overall calculation outcome of the projects 512-516 associated within a specific scope 501, a new calculation may also being initiated. This calculation may be initiated by an event that informs all scopes 501-509 that are involved in the particular activity that at least one subordinate scope 501 has been changed and thus a new calculation may be necessary.

Further, in order to create a new project 512, in at least one embodiment, a base scenario is defined that includes a project type, beginning and ending of the projects, calculation schemes, layer system, and potentially site/facility information. However, these elements identified as being part of a base scenario serve as illustrative examples and in other implementations could be different, including, alternative or other additional elements.

In at least one embodiment, project types 512-516 differ in the way resources are consumed over time. In particular, static projects and dynamic projects are two different project types which behave differently. In static projects, over a time span from beginning to end of production, a constant quantity is produced, while in dynamic projects, this quantity may vary over different time periods within the time from beginning to end of production.

For example, in a static project, costs are generated by the consumption of resources over time. This project type provides a defined starting point and a defined ending point in time. Over this time period, from start to end, a constant quantity is produced, e.g., normally a quantity of 1, for example, one project outcome. Therefore, for static project types, the analysis of different time phases within the overall time frame is not as important as the analysis of costs that are created over the whole project time period. Therefore, typically only one time phase is involved, in particular, the time phase between the beginning and ending of a project.

The elements and resources in a project of project type “static project” may be characterized by starting and ending points in time. In case the elements and resources of a static project do not have associated an explicit value in terms of the starting and ending points in time, the elements and resources may take on the time frame of the super-ordinate object, i.e., the project or scope.

Also, the elements and resources in a static project may have time-wise interdependencies. For example, values, such as the prices of parts that may vary over time may be allocated according to an end point in time that is valid for the respective resource.

In a project of project type “dynamic project,” the costs instead are generated based on multiplying the resource allocation with the planned number of units. The number of units may vary over different time phases of the overall project time frame. Therefore, in a dynamic project, starting and ending points of a project only represent start of production (SOP) and end of production (EOP). Nevertheless, elements and resources in dynamic projects may have associated start and end points in time that render, in that embodiment, the respective objects valid and provide a calculation during that defined time frame, i.e., between starting and ending points associated with the element.

As the differing time phases between SOP and EOP therefore in a dynamic project are of particular importance, the granularity of these time phases can be adjusted specifically for any respective and dynamic project. In one embodiment, the time phases, or rather, slices of time are adjusted such that the produced quantity is constant over each of these time slices. Therefore, in this embodiment, the overall quantities are allocated to the adjusted time slices. This may be done automatically, that is by an even distribution, or individually for each of the time phases.

For static projects, in contrast, there is only one time slice, the time phase between the start and end of the project. Therefore, the quantity is automatically distributed completely during this one time phase. Generally, for many of the static projects, it can be assumed that this quantity is 1.

In at least one embodiment, projects of either the “static” or “dynamic” type can be inserted into an existing structure of scopes and projects, such as scopes 501-509 and projects 512-516. Subordinate projects 514-516 may be inserted as elements and/or resources below super-ordinate projects 512 in the above-described hierarchical structure of scopes 501 and projects 512-516. A subordinate project 516 may have calculation schemes that differ from those provided by the super-ordinate project 512. Furthermore, a subordinate project 514-516 may be associated with any project scope 501-509, such that an inserted project 516 is automatically associated within the scope of the super-ordinate project 512. Moreover, the elements and resources of the subordinate project may be modified within the super-ordinate projects.

In addition to the above-mentioned base scenario for the creation of a new project, a project may be associated with a number of attributes that serve as input parameters for the definition of the project. In particular, these project attributes may comprise metadata, such as a project identifier, a project description, and/or a unique project number. Further, additional attributes for a project may include project-specific currency, the timeframe of the project, prices, administration, the association to project scopes, and in particular, for a created scenario, for example, attributes for a site/facility, a layer model, calculation schemes, customers, and/or suppliers. However, these attributes serve as illustrative examples of attributes that may be desirable as input parameters for a created project and other additional or alternative attributes may be defined.

FIG. 6 illustrates a static structure of the classes of a program translator engine that generates a configuration object from a given configuration file. In particular, program language translator 600, is a compiler/parser that generates a resource configuration object, for example, configuration object 440, from a given configuration file, for example configuration file 430. FIG. 6 shows the static class structure of the translator and of the class “resource configuration.”

As described above, the generated configuration object (e.g., configuration object 440) of the class “resource configuration” provides for the calculation of values of the “provider” calculation variables of the various resource signatures it provides. When a resource is requested to obtain the value of a variable, for example by way of a graphical user interface of an application, the resource uses the one or more expressions that are associated to its signatures and the variable in order to calculate the requested value.

Further, as described, the generated configuration object performs the administration of information about the dependencies between the various calculation variables. With respect to the graphical user interface, the generated configuration object provides the configured resource type, i.e., the resource signature for the display and administration of the graphical user interface's presentation.

The elements of the static class structures 600 illustrated in FIG. 6 are now explained. The “configuration context” is the starting point for the graph of the configuration objects. At run time, in particular when the application is starting, a new configuration context is generated, which is initialized by way of a string (the string having been configured according to the domain-specific language) or a file, the file containing a configuration according to the domain-specific language. In other words, when the application starts by reading a configuration file, such as file 430, a new configuration context is initialized. The configuration context instantiates the translation class by way of the configured string or configuration file.

The instantiated translator object (e.g., program code translator object 435) translates the string/configuration file and thereby generates the graph of a configuration object. This procedure can also be interpreted as the compiling of the configuration string or configuration file into an object graph. In at least one embodiment, the translator object is implemented as a parser.

The calculation factory class provides the method for the generating of new calculation variables, resource signatures, expressions and the like. This calculation factory class is used by the translator class.

Note that the translator class, from which the translator object is instantiated, may be implemented as a parser class. The program code of the translator class is, in one embodiment, generated by a translator generator, based on the formal grammar, syntax and elements of the domain-specific language such as domain-specific language 415. In at least one embodiment, the code of the translator object is a C# code and the C# code of the translator class, typically a parser class, is generated by a parser generator. The grammar of the domain-specific language for that purpose contains at least some defined rules and program code fragments, which can be built into the code of the translator class by the translator generator. Typically, the grammar of the domain-specific language contains C# code fragments, or C# snippets, which can be built into the code of the translator or parser class, by a parser generator. This generation of the translator class, however, is performed using the application design environment, for example at design level 320, illustrated in FIG. 3. Accordingly, the parser or translator class is provided ahead of a particular application configuration/generation and pertains to a domain-specific language 415, and is therefore not changed during application configuration 405 or application execution 410. The actual translation (of a configuration) is thus done by an instance of the translation class (a translation object), which is generated from the configuration context that is generated based upon a configuration file 430.

The following example may further illustrate the way the translator works; the example is about translation rules for numbers in expressions:

Expression: Price*(1+PercentalCostSurcharge)+AbsoluteCostSurcharge:

For the translation of this expression string, a sum object is generated that consists of a product object (price*(1+PercentalCostSurcharge)) and a variable expression object (AbsoluteCostSurcharge). The product object has as a second factor, again a sum object, which has a first summand and the figure “1.”

The following grammar rules would determine what is to be executed during translation of such a number:

numberLiteralExpression [IParserContext context] returns
[IExpression expr]
:
DECIMAL
{
$expr =
context.CalculationFactory.CreateConstantExpression($DECIMAL.
Text);
}
;

This grammatical rule generates by way of the calculation factory, a new constant expression object, which will be initialized with the text of the translated number, in this case “1.” The generated object is handed back and works as a summand for the higher level sum object. In the event that at a later stage a constant expression object is requested, it would always hand back as a result of that query, its initializing value, in this case the value “1.” Similarly, a sum object will always hand back in response to such a request the sum of the values of the summand, and so on.

The translator generator then builds in the code, in this example, the calculation factory call, into the translator class.

The translator class further generates upon translation of a configuration defined according to the domain-specific language 415 an object graph that has as a starting object a resource configuration object (e.g., configuration object 440). The resource configuration object, as illustrated in FIG. 6, then provides several other objects that are also generated by the translator class. In particular, the resource configuration object provides a list of the declared calculation variables, a list of the scenario parameters, a list of the declared quantity variables that are the consumption values of the resources, and a list of the declared resource signatures, i.e., resource types.

Each calculation variable object, as illustrated in FIG. 6, is an object of the type calculation variable, and is therefore not only an identifier for a calculation variable, which can be used for calculation, but also for a display that can be edited or used within reports. The quantity variable object, as indicated in FIG. 6, is a particular calculation variable that serves to define the consumption values, for example, number of pieces, machine time, etc.

The recursive variable object is a specific type of calculation variable that contains the value of the aggregation of a calculation variable at the assigned sub-structure elements or sub-resources. An example might be the expression: “provides mass=sum (mass)” which configures, in this example, a recursive variable. The value of that recursive variable is the sum of the masses of the assigned sub-structure elements or sub-resources. For example, a module, “sum(mass)”, might reflect the sum of the masses of all built-in parts. The grammar and syntax of the domain-specific language 415 therefore contains at least a rule that is used during translation or rather compiling of such a configuration of recursive variables.

The resource signature class aggregates all configuration information that pertains to a specific resource type. In particular, the Boolean attribute “is structure element” indicates whether the specific resource type is of the element type, as for example sub-parts or assemblies, or whether it is of the type of “natural” or “normal” resources, such as machines, employees, etc. This information can later be used, for example, with a graphical user interface of the generated computer application for the purpose of exporting of a bill of materials. The resource signature class further comprises a list of calculation variables, i.e., variables that are provided from a resource of that specific signature. In addition, the resource signature, as indicated in FIG. 6, contains a list of parameters. Further, an association variable, meaning a variable providing the value of the consumption of a resource of that signature, is contained in the resource signature, as well as a list of all recursive variables. For all provided variables, an expression is provided with the resource signature, used for the calculation of the value of that resource. This expression is later used for the calculation of a specific resource in order to calculate the value of the variable.

The expression object, as illustrated in FIG. 6, provides a result in response to a request. With that request, a value provider must be given. Further, there are at least two types of expressions, namely simple expressions and assembled expressions. Examples of simple expressions are recursive expressions that provide as a result the value of the associated recursive variable of the value provider (the value provider being responsible for the calculation of that value). A further example of a simple expression might be a variable expression that provides as a result the value of a variable of the value provider. An even further example of a simple expression might be a constant expression that provides as a result the value of the constant of the expression.

For assembled expressions, an example might be a sum expression that provides as a result the sum of the results of the sub-expressions. A further example is a product expression that provides as a result the product of the results of the sub-expressions.

These expressions, however, are merely illustrative and different embodiments might provide additional or other expressions. Nevertheless, these examples serve for a better understanding of expressions.

The calculation dependency class, as illustrated in FIG. 6, contains the information about the dependencies between the different variables of an expression. This information is automatically generated based upon a configured expression. The calculation dependency ensures that, for a later performed calculation, only those variables necessary to answer a particular request are calculated. This serves to enhance the performance of the calculation and the overall application, especially in the case of rather complex configurations.

As indicated in FIG. 6, the calculation value provider is implemented as an interface by a concrete resource, for example, a specific module in a particular project. At run time, when the calculation value provider is requested to obtain the value of one of the provided variables, for example the value of the variable “mass,” the calculation value provider evaluates the expression of the signature of the variable “mass.”

Finally, with respect to the classes illustrated in FIG. 6, it is to be noted that the resource and the calculation value provider classes are the only classes of the classes shown in FIG. 6 that are not instantiated at server start time in at least one embodiment.

By using the domain-specific language for the configuration of an application object, the parameters and the calculation algorithms can be configured for an application instead of being specifically coded. The present techniques provide a mechanism for the configuration of objects, the parameters and calculation algorithms, the graphical user interface of the application, the database and the calculation algorithms without having to be specifically coded (for example, as methods of objects) for that application. Using these techniques, applications can be configured, in other word “programmed,” at a much higher level of abstraction. This configuration at a higher abstraction level makes use of program code for the graphical user interface, database and calculation, which is enabled to work with resource signatures and resources. This program code, which is thus reusable, can be provided by the application development system 402, as described in FIG. 4, during the design phase 320, as described in FIG. 3.

Subsequently, the code need not be developed during a specific project, but instead the application designer of a specific project needs only to define a configuration file 430 that references, by using the domain-specific language 415, the code fragments provided by the application development system 402. The code provided by the application development system 402 operates with a list of variables and dictionaries of values and expressions instead of working with specific, hard-coded properties. Further, it is to be noted that a configuration file translated by the compiler/parse illustrated in FIG. 6 is not first translated into program code and then compiled. In contrast, the translator object generated by the translated generator generates an object graph of instances of predefined configuration classes (configuration objects 420). This is illustrated by the example that has further been described above in a context of the translator object illustrated in FIG. 6.

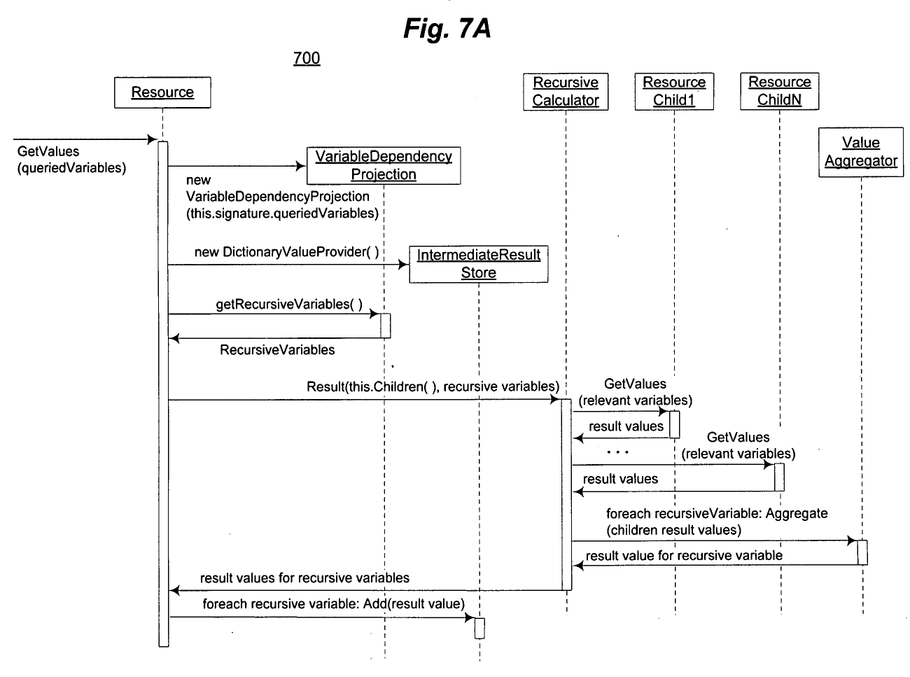

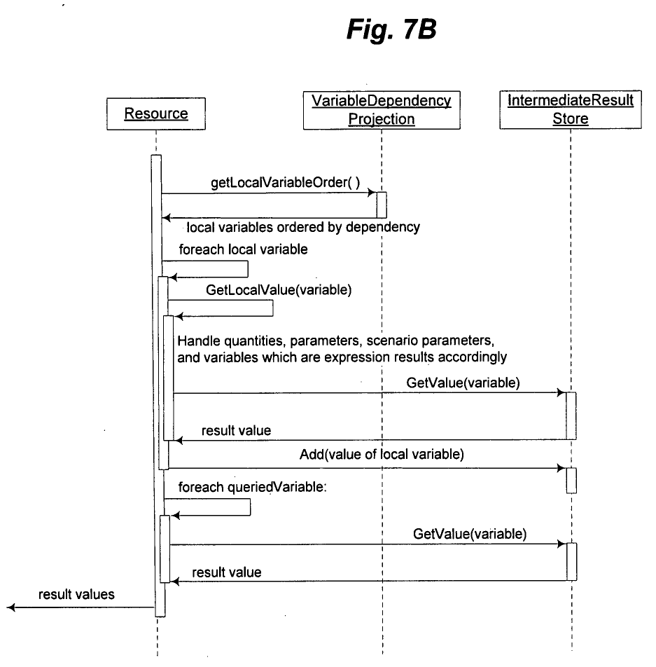

FIGS. 7A and 7B illustrate a sequence diagram that illustrates processing of a configured calculation. Sequence diagram 700 illustrates that the configuration objects generated by a translator object define the behavior and appearance of the computer application created using application configuration process/system 405.

In particular, the display and administration of resources, for example a module, are determined by the attributes configured for the resource type, that is, the signature of a particular resource. The configured parameters are displayed for user input and that the values of the provided configured variables are displayed as calculation results. The graphical user interface of the respective computer application can therefore be completely developed on a generic level and be provided by the application development system 402 at the design phase 320. In other words, based on the configuration of the resource types in the configuration file (e.g., configuration file 430) a graphical user interface of a computer application can be generated without further coding of any specific program code. Further, to obtain the values of variables of a resource, the respective calculation uses configured expressions based upon the user-defined values of the resource parameters.

In particular, sequence diagram 700 shows a GetValues( ) request on a specific resource. This request is provided with a list of the queried variables. The resource then generates a variable dependency projection. This variable dependency projection then evaluates the variables that have to be calculated for answering the request according to the dependencies of the variables. That means that all recursive variables that have to be calculated are evaluated and all local variables that have to be calculated are evaluated according to their evaluation sequence. Local variables for example may be parameters or provided variables.

The resource then generates an object (IntermediateResultStore) for storing the intermediate result. The resource then requests by invoking GetRecursiveVariables( ) the recursive variables that have to be calculated and uses the RecursiveCalculator to calculate the values of these variables. For that purpose it forwards a list of the sub-resources of these variables.

The RecursiveCalculator requests all sub-resources for the necessary values. Then, the RecursiveCalculator aggregates these values as the sum of the values of the sub-resources. The resource then stores these values in the IntermediateResultStore.

The resource then requests using getLocalVariableOrder( ) the local variables, which in this example are the parameters and provided variables that require calculation. Using getLocalValue( ), the resource calculates the values of the local variables in the right sequence. For a parameter, the value is simply the value of the parameter at that moment. For a provided variable, the value is the result of the evaluation of the corresponding expression. Here, the expression objects are requested that were generated by the translator object based on the configuration. For the recursive variables, the values are already in the IntermediateResultStore.

The resource then reads the values of the requested variables from the IntermediateResultStore and returns them to the caller.

Accordingly, it is guaranteed by the configuration defined in the configuration file that the values of the requested variables have been calculated on the basis of that configuration, the variable dependency projection, and the calculation sequence of the local variables.

Thus, sequence diagram 700 illustrates that the calculation in an application generated according to the techniques presented herein is performed by way of the object graph that has been generated by the translator.

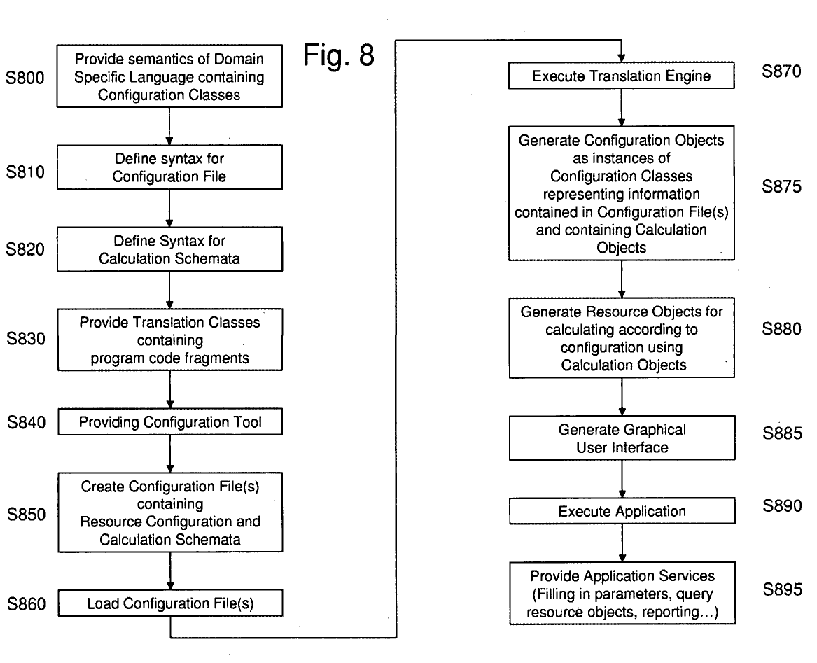

FIG. 8 is an example flow diagram of the process for software application development and application execution according to the presented techniques. Specifically, FIG. 8 illustrates the process of providing an application development system 402 at the design phase 320, for example using computer system 105, the generation of configuration files 430 during configuration phase 405 using, for example, computer system 110, and application execution 410 performed, for example, using computer system 115.

In particular, in step S800, a domain-specific language is provided which contains configuration classes as an abstract model. Then, using the semantics of the domain-specific language, at step S810 a syntax is defined for providing the configuration files, for example configuration files 430. Further, at step S820, a syntax is defined for calculation schemes which can be used within the definition of the configuration files. At step S830, calculation classes are provided containing program code fragments that allow for translating a configuration file into the object model. The steps S800 to S830 reflect the main steps used to provide an application development system at the design phase 420.

Turning to application configuration at configuration phase, in step S840, a configuration tool is provided. As noted, the providing of a configuration tool can be part of the application development system or can be done independently, as, in at least one embodiment, the configuration files are text files that could be generated using a wide variety of tools. However, in order to provide a user with a configuration tool that supports the correct definition of a configuration file according to the syntax and grammar of the domain-specific language, a specific configuration tool may be provided that by its graphical user interface and functionality ensures that a user can only create configuration files that are compatible and compliant with the rules, grammar and syntax of the defined domain-specific language.

Using the configuration tool provided in step S840, in step S850 a string, configuration file, or several configuration files are created that contain resource configurations and calculation schemes expressed according to the grammar and syntax of the domain-specific language provided in step S800. Step S850 therefore reflects the main step of the application configuration during the configuration phase. However, as mentioned, the providing of a configuration tool (step S840) can also be part of the application configuration at least in a case in which a specific configuration tool is not provided within the application development system.

In the next step S860. the configuration file is loaded onto a computer system, such as computer system 115. The system upon which it is loaded typically has access (directly or communicatively coupled) to the elements provided by the application development system as illustrated and discussed in the context of FIG. 1. In step S870, the translation engine provided by the application development then is executed to translate the loaded configuration files into an object graph that represents the application. Based on this translation, in step S875, configuration objects are generated as instances of the configuration classes that represent information contained in the configuration files and contained in the calculation objects provided in the configuration objects. Calculation objects contained in the configuration objects are also thereby generated. In step S880, resource objects are generated for performing calculations according to the configuration files. These resource objects use the calculation objects generated in previous step S875.

Using the objects generated in the previous steps, in step S885, a graphical user interface of the intended computer application is generated and the application is, from a user perspective, executed on computer system, such as computer system 115 in step S890. By presenting the graphical user interface and executing the application, the user is enabled in step S895 to make use of provided application services, for example, the filling in parameters, performing queries, requesting resource objects, reporting services, and the like.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments have been described herein for purposes of illustration, various modifications may be made without deviating from the spirit and scope of the present disclosure. For example, some or all of the methods, techniques, and systems for providing computer application projects and for generating computing application discussed herein are applicable to other architectures other than an object-oriented architecture. Also, the methods, techniques, computer program products, and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A computer-implemented method of providing an aggregation of project-specific computer applications, wherein the computer applications are developed based on configuration of resource objects within a project using a domain specific language for calculation tasks, comprising:
creating at least one project;
associating the at least one project with at least one scope in a hierarchical structure of project scopes, wherein the at least one scope comprises pre-configuration attributes that are automatically included in the at least one project as input parameters;
creating one or more configuration files using a domain specific language associated with the at least one project, the configuration files at least comprising declaration of a set of variables, a set of resources, and the structure of each resource; and
automatically generating, subsequent to an automated translation of the configuration files into an object model, a computer application, the application presenting a graphical user interface and performing calculation tasks upon user input as defined in at least one of the one or more configuration files, wherein the translation and the performing of calculation tasks is at least in part based on the pre-configuration attributes defined within the scope that have been automatically included in the at least one project.

2. The method of claim 1, wherein the domain specific language defines a syntax for configuration of resource objects, each element of the syntax having assigned a generalized functionality, and further comprising:
providing a set of configuration classes defining an abstract object model implementing the generalized functionality of the domain specific language; and
wherein the declaration of the structure of a resource in the one or more configuration files comprises:
declaration of a resource signature, the resource signature determining the attributes of the resource and the calculation schemes used by the resource; and
declaration of the resource assignment associating other resources as sub-resources to the resource.

3. The method of claim 2 wherein the generalized functionality provides for generating of a graphical user interface and performing of calculation tasks upon user input, and wherein the automatically generating the computer application and performing of calculation tasks as defined in the one or more configuration files depends on a configuration of resource objects defined according to the structures of the resources.

4. The method of claim 1 wherein the declaration of the set of variables comprises:
declaration of at least one quantity variable, the quantity variable expressing the consumption of a resource.

5. The method of claim 1 wherein the declaration of the set of variables comprises:
declaration of at least one calculation variable, the calculation variable for specifying a result of a calculation or a parameter of a calculation.

6. The method of any of claim 1 wherein the declaration of the set of resources further comprises:
declaration of a set of elements, elements being part of a product structure.

7. The method of claim 1 wherein the declaration of the structure of each resource comprises:
definition of the resource signature of the resource, the resource signature at least comprising a quantity variable, the quantity variable expressing the consumption of the resource and being declared in the set of variables, an element as a parent resource consuming the resource as a child resource, and a calculation scheme for calculating the amount of the quantity variable caused by consumption.

8. The method of claim 7 wherein the resource signature for at least one resource further comprises:
a calculation variable being declared in the set of variables and specifying, as a caused variable, the result of the calculation scheme.

9. The method of claim 7 wherein the resource signature for at least one resource further comprises:
a set of parameter variables, the parameter variables being part of the calculation scheme and a value of a parameter variable being determined based on user input.

10. The method of claim 1 wherein the automated translation of the configuration files into the object model further comprises:
reading at least one of the one or more configuration files;
generating a variable dependency determining the interdependency of the calculation variables defined in a resource signature that comprises the structure of one of the resources; and
generating an aggregator for summing up any calculation variable that is based on values of caused variables of child resources of one of the resources.

11. The method of claim 1, further comprising:
providing the domain specific language by providing one or more meta-resource types, each meta-resource type at least being determined by the type of quantity variable, a list of parameters, and a calculation scheme.

12. The method of claim 11 wherein the meta-resource types comprise at least one of substance, module, machine, or employee.

13. A computer-readable medium having stored thereon computer-readable instructions that, when executed on a computing system, are configured to performing a method comprising:
creating at least one project;
associating the at least one project with at least one scope in a hierarchical structure of scopes, wherein the at least one scope comprises pre-configuration attributes that are automatically included in the at least one project as input parameters;
creating one or more configuration files using a domain specific language associated with the at least one project, the configuration files at least comprising declaration of a set of variables, a set of resources, and the structure of each resource; and
automatically generating, subsequent to an automated translation of the configuration files into an object model, a computer application presenting a graphical user interface and performing calculation tasks upon user input as defined in at least one of the one or more configuration files, wherein the translation and the performing of calculation tasks is at least in part based on the pre-configuration attributes defined within the scope that have been automatically included in the at least one project.

14. A computing system configured for aggregated calculation of project-specific computer applications, wherein the computer applications are developed based on a configuration of resource objects using a domain specific language for calculation tasks and the computer applications are executed on the computer system, comprising:
a language design module, having stored thereon a syntax for a domain specific language for configuration of resource objects, each element of the syntax having assigned a generalized functionality, a set of configuration classes that define an abstract object model implementing the generalized functionality of the domain specific language, and a set of translation classes for translating a configuration file into configuration objects and resource objects, the generalized functionality defining a user interface for interacting with configured resource objects within the domain;
a configuration file specification tool, configured to generate and store on a memory one or more configuration files that declare and define one or more of the resource objects according to the domain specific language; and
an execution module stored on a memory that is configured to, when invoked, generate an application by causing translation objects to be instantiated for the translation classes, the translation objects being further executed to instantiate the configuration objects and resource objects for a particular implementation, the structure of the resource objects defining how the user interface of the application is presented, and to calculate values of the generated application according to the domain specific language.

15. The system of claim 14, each configuration file comprising a declaration of a set of variables, a set of resources and a definition of the structure of each resource.

16. The system of claim 14, wherein the declaration of the set of variables for a resource comprises declaration of a quantity variable that defines a unit of consumption of the resource.

17. The system of claim 14, wherein the declaration of the set of variables for a resource comprises declaration of at least one calculation variable, the calculation variable for specifying a result of a calculation or a parameter of a calculation.

18. The system of claim 14, the definition of the structure of at least one resource comprising a quantity variable that is declared in the set of variables, that defines how the resource is consumed by another resource, and a calculation variable that is declared in the set of variables and whose associated calculation scheme is executed to calculate values for the resource, according to a domain specific language, based upon user input.

19. The system of claim 14, the language design module having further stored thereon at least one project that is configured to operate applications within a scope of a hierarchy of scopes, the at least one project automatically determining one or more input values for the application generated using the one of the one or more configuration files.

20. The system of claim 19 wherein the scopes are project scopes that are used to organize resources for applications.

21. The system of claim 14 wherein the at least one of the one or more configuration files is at least one of an array, a string, a database, or a file.
